(19) United States
(12) Patent Application Publication
(10) Pub. No.: US 2007/0008356 A1
(43) Pub. Date: Jan. 11, 2007

(54) Image reproducing/forming apparatus with print head operated under improved driving waveform

(76) Inventor: Tomomi Katoh, Tokyo (JP)

Correspondence Address: COOPER & DUNHAM, LLP, 1185 AVENUE OF THE AMERICAS, NEW YORK, NY, 10036, US

(21) Appl. No.: 10/549,791

(22) PCT Filed: Apr. 28, 2004
(86) PCT No.: PCT/JP04/06204

§ 371 Date: Sep. 19, 2005

(30) Foreign Application Priority Data
May 2, 2003 (JP) 2003-127156

(51) Int. Cl. B41J 29/38

(52) U.S. Cl. 347/10

(57) ABSTRACT

An image reproducing and forming apparatus comprises an ejection head that ejects a liquid droplet from a nozzle to form an image on a medium, a driving signal generating unit that generates a driving signal including an ejecting pulse for ejecting the droplet and a non-ejecting pulse that produces energy for not ejecting the droplet, and a driving unit that applies the ejecting pulse to the ejection head in a printing range and applies the non-ejecting pulse to the ejection head in a non-printing range in order to drive the ejection head at a driving frequency other than the natural frequency of the ejection head.

### BACKGROUND OF THE INVENTION

The present invention generally relates to an image reproducing/forming apparatus, and more particularly, to an image reproducing/forming apparatus using an ejection head driven under reduced influence of resonance.

Certain types of image reproducing/forming apparatuses, such as printers, facsimile machines, coping machines, or plotters, employ inkjet printing equipment to reproduce a hardcopy image on a medium. Inkjet printing equipment generally includes an inkjet head having a set of nozzles for ejecting ink droplets. In the inkjet head, an ink chamber (which is also referred to as a pressure chamber or an ink flow channel) is arranged so as to communicate with each nozzle opening, and an ink droplet is ejected from the nozzle opening upon application of pressure to the ink in the ink chamber by an actuator or other suitable pressure generating means.

There are several types of inkjet heads known. A so-called piezo-type inkjet head uses a piezoelectric element as the pressure generating means, which deforms the walls of the ink flow channel to change the volume of the ink chamber and eject ink droplets. A thermal-type inkjet head uses a heating resister for heating the ink and producing bubbles in the ink chamber to eject an ink droplet under pressure. An electrostatic-type inkjet head uses a vibrating plate defining the ink flow channel and an electrode facing the vibrating plate. Electrostatic force is produced between the electrode and the vibrating plate, which force deforms the vibrating plate and changes the volume of the ink flow channel, thereby ejecting ink droplets.

Inkjet heads using the vibrating plate are further categorized into several types. One type is to push the vibrating plate into the ink chamber to reduce the volume of the chamber in order to discharge ink droplets. Another type is to pull the vibrating plate outward to expand the volume of the ink chamber and then to bring the vibrating plate back to the original position to discharge ink droplets. Still another type is to drive the inkjet head by a combination of the push-discharge method and the pull-discharge method.

In general, an inkjet printing unit has several tens or more nozzles for each color, and nozzles to be driven to eject ink droplets are selected according to the pixel data in order to form an image on the medium. When a number of nozzles are driven (by activating the pressure generating means), the reaction force caused by the pressure for discharging ink droplet acts on the inkjet head itself. For this reason, the head shakes under the application of ink-ejecting pressure, depending on the pixel data, and resonance occurs at the natural frequency (eigen frequency) of the head.

If the head is driven at a frequency near the resonant frequency, ejected droplets may curve in flight through the air, the droplet size may change, or satellite particles may form. In such cases, a correct image may not be reproduced.

To overcome this problem, JPA 9-29962 discloses a technique for varying the effective lengths of the actuators (electromechanical transducers) in order to reduce mutual interference due to resonance, thereby removing adverse influence on the reproduced image.

However, the machining process for fabricating different sizes of actuators is inefficient, and the head structure becomes complicated.

### SUMMARY OF THE INVENTION

Therefore, it is an object of the present invention to provide an image reproducing and forming apparatus that can reduce adverse influence of resonance with a simple structure and output an image with improved print quality.

To achieve the object, the head driving unit drives the ejection head of the apparatus at a driving frequency other than the natural frequency of the ejection head.

In one aspect of the invention, an image reproducing and forming apparatus comprises an ejection head configured to eject a liquid droplet from a nozzle to form an image on a medium, a driving signal generating unit configured to generate a driving signal having a waveform that causes the ejection head to operate at a driving frequency other than the natural frequency of the ejection head, and a driving unit configured to drive the ejection head based on the driving signal supplied from the driving signal generating unit.

Preferably, the driving signal generating unit produces the driving signal including a non-ejecting pulse that produces energy for not ejecting the droplet, and the driving unit applies the non-ejecting pulse to the ejection head in a non-printing range in order to drive the ejection head at a driving frequency other than the natural frequency of the ejection head.

The non-ejecting pulse may be produced making use of a portion of an ejecting pulse for ejecting the droplet in the driving signal.

The non-ejecting pulse may be a pulse that draws in the nozzle meniscus. In this case, it is preferable that the rate of voltage change for drawing in the nozzle meniscus be greater than the rate of voltage change for restoring the nozzle meniscus.

Alternatively, the non-ejecting pulse may be a pulse that pushes out the nozzle meniscus. In this case, it is preferable that the width-of the non-ejecting pulse is smaller than the period of pressure-induced resonance in the liquid chamber of the ejection head.

The driving signal may include a first waveform that pushes out the nozzle meniscus and a second waveform that follows the first waveform to draw in the nozzle meniscus, the pulse width of the first waveform being smaller than the resonant frequency of the liquid chamber of the ejection head.

### BRIEF DESCRIPTION OF THE DRAWINGS

Other objects, features, and advantages of the present invention will become more apparent from the following detailed description when read in conjunction with the accompanying drawings, in which:

FIG. 1 is a perspective view of the major parts of an inkjet printer to which the present invention is applied;

FIG. 2 is a cross-sectional view of the inkjet printer;

FIG. 3 is a cross-sectional view of the inkjet head used in the inkjet printer, taken along the longitudinal axis of the ink chamber;

FIG. 4 is a cross-sectional view of the inkjet head, taken along the width of the ink chamber;

FIG. 5 is a block diagram of the control section of the inkjet printer;

FIG. 6 is a block diagram of the head driving control mechanism;

FIG. 7 illustrates general waveforms of head driving pulses for ejecting different sizes of ink droplets;

FIG. 8 is a graph used to explain the resonant frequency characteristic of the head;

FIG. 9 is the first example of waveforms of the head driving signal produced according to the preferred embodiment of the invention;

FIG. 10 is the second example of waveforms of the head driving signal;

FIG. 11 is the third example of waveforms of the head driving signal;

FIG. 12 is the fourth example of waveforms of the head driving signal;

FIG. 13 is the fifth example of waveforms of the head driving signal;

FIG. 14 is the sixth example of waveforms of the head driving signal;

FIG. 15 is a cross-sectional view showing the structure of the head used in the actual example; and

FIG. 16 illustrates an image pattern used in evaluation of printing performance.

### PREFERRED EMBODIMENTS OF THE INVENTION

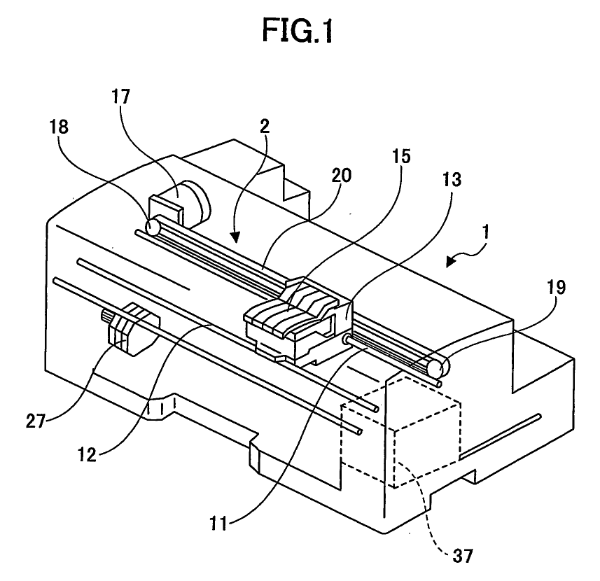

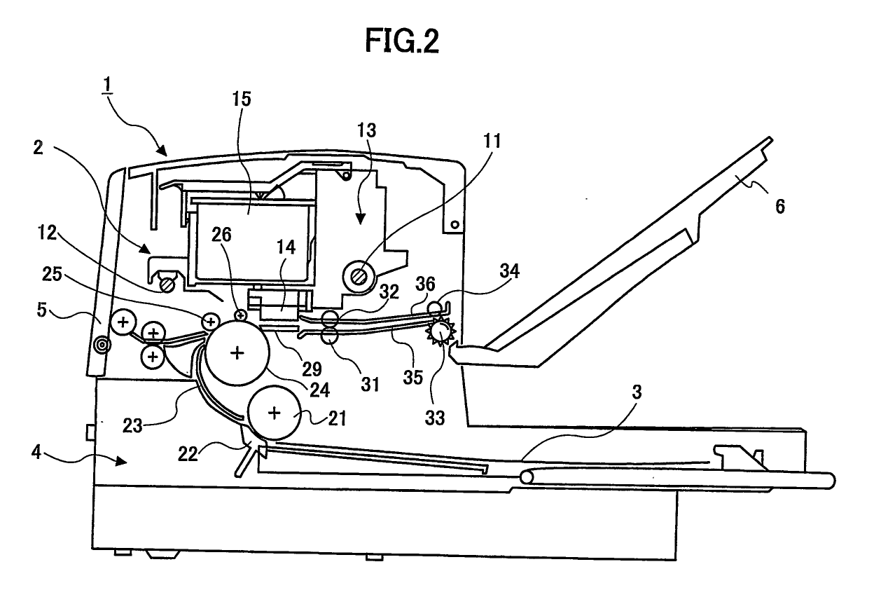

The preferred embodiments of the invention are described below with reference to the attached drawings. FIG. 1 and FIG. 2 illustrate an inkjet printer, which is an example of an image reproducing and forming apparatus to which the present invention is applied. FIG. 1 is a perspective view of the major part of the inkjet printer, and FIG. 2 is a cross-sectional view of the inkjet printer.

In the inkjet printer, a printing mechanism 2 is housed in a main frame 1. The printing mechanism 2 includes a carriage 13 movable in the fast scan direction, an inkjet head (functioning as the print head) 14 mounted on the carriage 13, and an ink cartridge 15 for supplying ink to the inkjet head 14. Paper is fed into the printer from the paper cassette 4 or the manual feed tray 5, and a prescribed image is reproduced (or printed) on the paper by the printing mechanism 2. Then, the printed paper is fed out onto the catch tray 6.

In the printing mechanism 2, the carriage 13 is held by the primary guide rod 11 and the secondary guide rod 12 in a sliding manner in the fast scan direction (perpendicular to the sheet of FIG. 2). The inkjet head 14 is attached to the carriage 13 with the inkjet surface facing down. The inkjet head 14 ejects ink droplets of each color of yellow (Y), cyan (C), magenta (M), and black (B). Above the carriage 13 are provided ink cartridges for supplying the respective colors of ink in a replacable manner.

The ink cartridge 15 has an opening to the air on the top face, and ink supply ports for supplying ink to the inkjet head 14 on the bottom face. Inside the ink cartridge 15 is a porous material filled with ink, and the ink to be supplied to the inkjet head 14 by the capillary force of the porous material is retained at a slightly negative pressure.

The carriage 13 is held by the primary guide rod 11 at the rear (located downstream of the paper path), in a sliding manner, and it is held by the secondary guide rod 12 at the front (located upstream of the paper path) in a sliding manner. In order to move the carriage 13 in the fast scan direction, a timing belt 20 is put around the driving pulley 18 rotated by the fast scan motor 17 and the sub pulley 19. The timing belt 20 is fixed to the carriage 13, and the carriage 13 is moved back and forth by the forward and reverse rotation of the fast scan motor 17.

Multiple inkjet heads 14 may be provided corresponding to the respective colors, or alternatively, a single inkjet head 14 having nozzles for ejecting ink droplets of the respective colors may be employed. In either case, the inkjet head 14 is of a piezo type, and has a vibrating plate defining at least a portion of the wall of the ink flow channel and a piezoelectric element for deforming the vibrating plate.

A sheet of paper is pulled out of the paper cassette 4 by the feed roller 21 and the friction pad 22. The paper 3 is then guided by the guide 23, and the direction of the paper is inverted by the feed roller 24. A roller 25 is pressed against the rotating surface of the feed roller 24. An edge roller 26 controls the delivery angle of the paper 3 from the feed roller 24 to beneath the inkjet head 14. The feed roller 24 is rotated by the slow scan motor 27 via a set of gears.

A paper catch guide 29 is positioned beneath the inkjet head 14 corresponding to the moving range of the carriage 13 extending in the fast scan direction. The paper catch guide 29 receives and holds the paper 3 fed from the feed roller 24 during the printing operation by the inkjet head 14, and then guides the printed paper 3 toward downstream of the paper path after the printing operation. The paper 3 bearing the printed image is further fed along the paper path and ejected onto the catch tray 6 by the roller 31 and the spur 32, the guides 33 and 36, and the roller 33 and the spur 34.

During the printing operation, the inkjet head 14 is driven to eject ink droplets onto the stationary paper 3 according to the pixel signals, while it is moved in the fast scan direction together with the carriage 13. When a line of the image is printed, the paper 3 is fed in the slow scan direction by a predetermined amount, and the next line of image is printed. In response to an end-of-print signal or a signal indicating that the trailing edge of the paper 3 has reached the printing zone, the printing operation is terminated, and the paper 3 is ejected.

A maintenance unit 37 for correcting a defective ink-jet condition in the inkjet head 14 is placed out of the carriage moving range so as to be offset from the printing zone, as illustrated in FIG. 1. Although not shown in the figures, the maintenance unit 37 includes a cap, a suction device, and a cleaning device. In the waiting state, the carriage 13 moves toward the maintenance unit 37, where the inkjet head 14 is capped in order to prevent the ink in the nozzle from evaporating and to maintain the nozzle openings (ejection ports) moist. By purging excessive amounts of ink unnecessary for printing between the printing operations, the ink viscosity can be maintained constant at all the nozzle tips.

If something is wrong with the ink ejection condition, the nozzles of the inkjet head 14 are capped tightly, and the bubbles and the ink are suctioned from the ejection ports by the suction device through tubes. Dust and ink-adhering to the ejection ports are also removed by the cleaning device to restore the good ejection condition. The suctioned ink is drained to the drainage reservoir (not shown) placed under the main frame 1, and absorbed in the ink absorber in the reservoir.

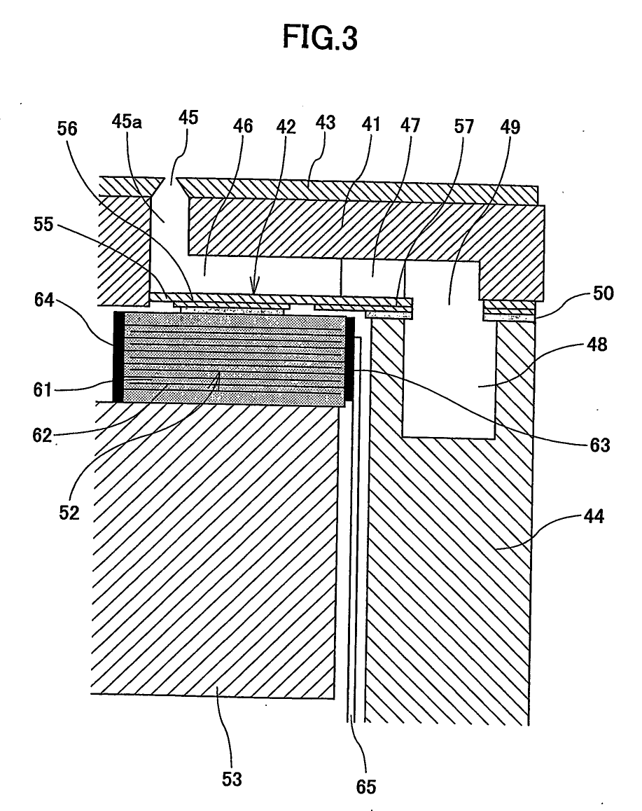

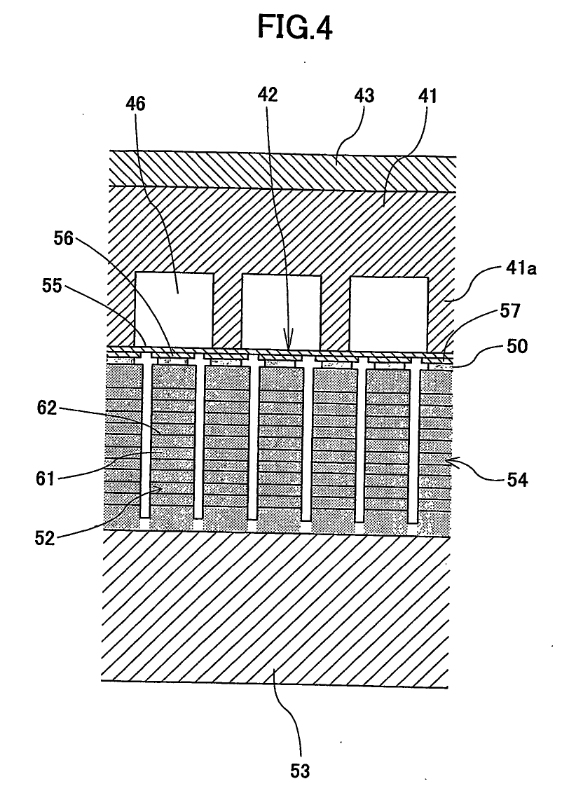

FIG. 3 and FIG. 4 illustrate an example of the inkjet head 14. FIG. 3 is a cross-sectional view taken along the longitudinal axis of the ink chamber, and FIG. 4 is a cross-sectional view taken along the width of the ink chamber.

The inkjet head 14 has a channel plate 41 made of a single crystalline silicon substrate with a prescribed channel pattern formed therein, a vibrating plate 42 attached to the bottom of the channel plate 41, and a nozzle plate 43 attached to the top of the channel plate 41. The channel plate 41, the vibrating plate 42, and the nozzle plate 43 define a nozzle opening 45, a nozzle cavity 45a, a pressure chamber 46 communicating with the nozzle opening via the nozzle cavity 45a, and an ink supply channel 47. The ink supply channel 47 functions as a fluid resister and communicates with the common ink chamber 48 for supplying ink to the pressure chamber 46 via the ink supply port 49.

A laminated piezoelectric device is supported on the base board 53, and is attached to the outer face (on the opposite side of the ink chamber) of the vibrating plate 42 in such a manner that each piezoelectric element 52 corresponds to one of the pressure chambers 46 (FIG. 4). The piezoelectric element 52 is an electromechanical transducer, which functions as a pressure generator (or an actuator) for applying pressure to the ink in the pressure chamber 46. A support section 54 is located between each two adjacent piezoelectric elements 52. The support sections 54 are positioned corresponding to the partition walls 41a located between each two adjacent pressure chambers 46. In the example shown in FIG. 4, the piezoelectric member is machined into a comb shape by defining a plurality of slits using a half-cut dicer. The piezoelectric elements 52 and the supports 54 are arranged alternately with the slits between them. The structure and the material of the support 54 and the piezoelectric element 52 are the same. However, since no driving pulse is applied to the support 54, it functions merely as a support.

The periphery of the vibrating plate 42 is bonded to the frame 44 using adhesive 50 containing gap spacers a recess that becomes the common ink chamber 48 and an external ink supply port (not shown) for externally supplying ink into the common ink chamber 48 are formed in the frame 44. The frame 44 is formed by injection molding using, for example, an epoxy resin or polyphenylene sulfide.

The channel plate 41 with the nozzle cavity 45a, the pressure chamber 46, and the ink supply channel 47 are fabricated by performing anisotropic etching on a (110) single crystalline silicon wafer using an alkaline etchant, such as potassium hydrate (KOH) solution. Of course, stainless boards or photosensitive resins may be used as the channel plate, in place of the single crystalline silicon wafer.

The vibrating plate 42 is made of nickel, and is fabricated by, for example, electroforming. Of course, other suitable metal plates, plastic plates, or combinations of metal and plastic may be used. The vibrating plate 42 has a flat surface, which is bonded to the channel plate 41, and an opposite uneven surface, which is bonded to the piezoelectric device and the frame 44. The uneven surface of the vibrating plate 42 includes thin portions (diaphragms) 55 located corresponding to the pressure chambers 46 for facilitating deformation, and thick portions (islands) 56 located corresponding to the piezoelectric elements 52. The islands 56 are bonded to the respective piezoelectric elements 52 via adhesive 50. The uneven surface of the vibrating plate 42 also includes thick portions 57, which are bonded to the supports 54 and the frame 44 via adhesive 50. In this example, the vibrating plate 42 is a double-layered nickel plate fabricated by electroforming. In this case, the thickness and the width of the diaphragms 55 are 3 μm and 35 μm, respectively.

The nozzle plate 43 has nozzle openings 45 with a diameter of 10-35 μm at positions corresponding to the pressure chambers 46. The nozzle plate 43 is bonded to the channel plate 41 by adhesive, such that the nozzle openings 45 communicate with the nozzle cavities 45a formed in the channel plate 41. The nozzle plate 43 may be made of metal, such as nickel or stainless, a combination of metal and resin (e.g., a polyamide resin film), silicon, or any combination thereof. In this example, the nozzle plate 43 is a nickel plate formed by electroforming. The nozzle opening 45 is shaped likes a horn (or cylindrical or a truncated cone), the inner diameter of the nozzle opening 45 on the ink ejecting side is about 20-35 μm, and the nozzle pitch of each line is 150 dpi.

Although not shown in the drawing, the nozzle surface (or the ejection surface) of the nozzle plate 43 is covered with a water-shedding coat. Water-shedding coating methods and material can be selected appropriately depending on the ink properties, so as to achieve the desired shape of ink droplets, which shape is stable flying through the air, and high image quality. For example, eutectic PTFE-Ni plating, fluoropolymer electro-deposition coating, vapor deposition using evaporable fluoropolymer (e.g., fluorocarbon pitch), baking after fluoropolymer flux coating, and other suitable methods may be employed.

The piezoelectric element 52 includes alternately laminated piezoelectric layers 61 and internal electrode layers 62. The piezoelectric layer 61 is made of PZT (Lead Zirconium Titanate) with a thickness of 10-50 μm, and the internal electrode layer 62 is made of Ag-Pd (silver-palladium) alloy with a thickness of several microns. The internal electrodes 62 are interlaced and electrically connected alternately to the individual electrode group 63 and the common electrode 64, as illustrated in FIG. 3. The individual electrodes 63 and the common electrode 64 are provided on the opening end surfaces of the piezoelectric device as external electrodes. The piezoelectric element 52 has a piezoelectric constant of d33, and expansion and contraction of the piezoelectric element 52 causes the pressure chamber 46 to expand and contract. When a driving signal is applied for electrical charging to the piezoelectric element 52, it expands. When the electric charges accumulated in the piezoelectric element 52 are discharged, it contracts.

The external electrode provided on one end face of the piezoelectric device is divided into a plurality of individual electrodes 63 by half-cut dicing. The other external electrode is a common electrode 64 used in common for all the piezoelectric elements 52. The common electrode 64 is not divided because of restrictions due to cutaway machining.

An FPC cable 65 is coupled to the individual electrode 63 by soldering, ACF (anisotropic conductive film) bonding, or wire bonding, to supply a driving signal to the piezoelectric element 52. The other end of the FPC cable 65 is connected to a driving circuit (driver IC), which selectively applies a driving pulse to each of the piezoelectric elements 52. On the other hand, the common electrode 64 is electrically connected to the ground (GND) electrode of the FPC cable 65 via an extraction electrode.

In the inkjet head 14, a driving puls (at 10-50 V) is applied to the piezoelectric element 52 in response to a print signal to cause the piezoelectric element 52 to deform in the layered (or laminated) direction. This deformation applies pressure to the ink in the pressure chamber via the vibrating plate 42, and consequently, an ink droplet is ejected from the nozzle opening 45.

Once the ink droplet has been ejected, the pressure in the pressure chamber 46 decreases and negative pressure is produced in the pressure chamber 46 due to the inertia of the ink flow and the electrical discharge of the driving pulse. Consequently, additional ink is introduced into the pressure chamber 46. To be more precise, the ink supplied from an ink tank (not shown) flows into the common ink chamber 48, and into the pressure chamber 46 via the ink supply port 49 and the ink supply channel (fluid resister) 47.

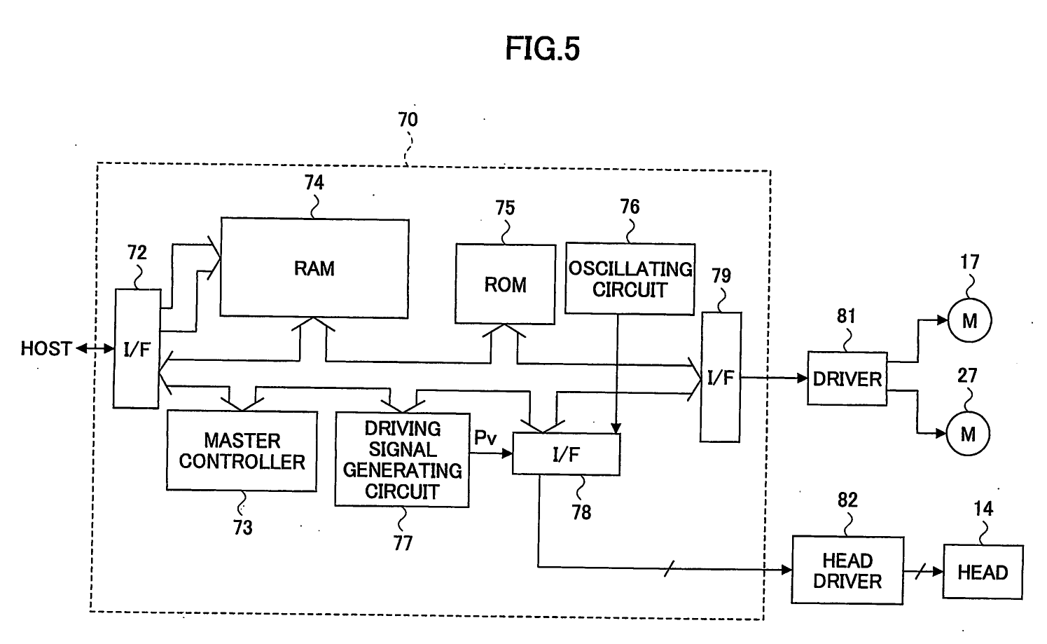

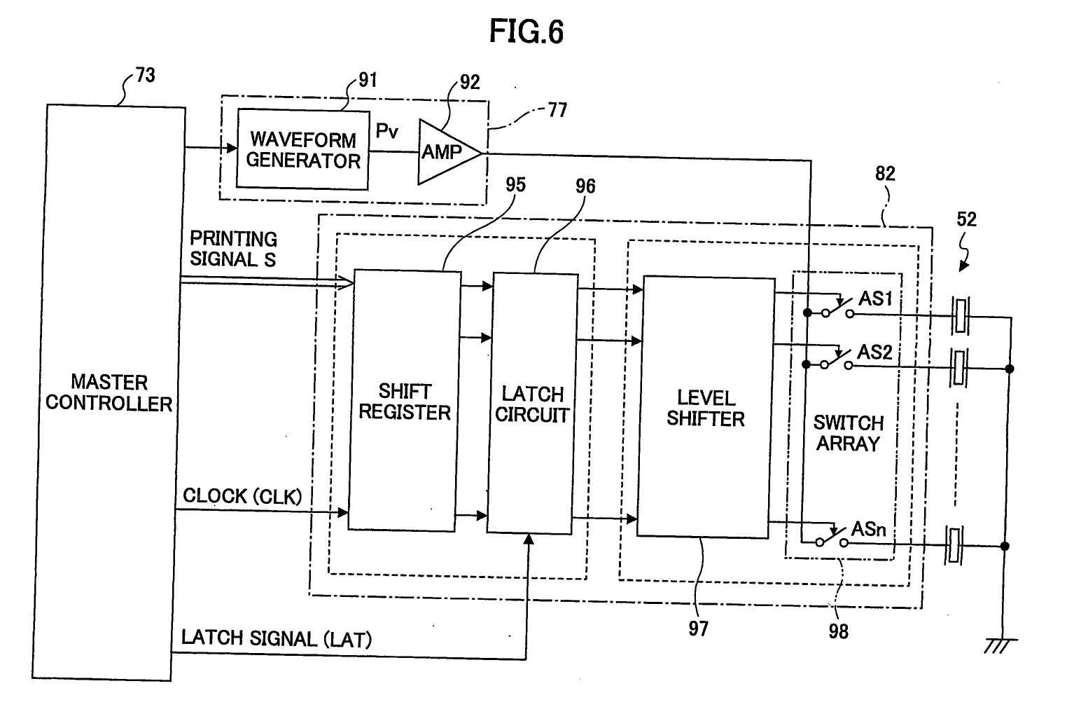

FIG. 5 and FIG. 6 illustrate the control section of the inkjet printer. FIG. 5 is a block diagram showing the overall structure of the control section, and FIG. 6 is a block diagram of the head driving control mechanism.

The control section includes a printer controller 70, a motor driver 81 for driving the fast scan motor 17 and the slow scan motor 27, and a head driver 82 for driving the print head (inkjet head) 14. The head driver 82 is comprised of a head driving circuit or a driver IC.

The printer controller 70 includes an interface (I/F) 72 receiving print data from the host computer via a cable or a network, a master controller 73 (such as a CPU), a RAM 74 holding various types of data, a ROM 75 storing routines for processing the data, an oscillating circuit 76, and a driving signal generating circuit (or driving waveform generator) 77 configured to generate a driving waveform supplied to the inkjet head 14. The printer controller 70 also includes an interface (I/F) 78 for transmitting the print data converted into dot pattern data (bitmap data) and driving waveforms to the head driver 82, and an interface (I/F) 79 for transmitting motor driving data to the motor driver 81.

RAM 74 is used as buffers and a work memory. ROM 75 stores control routines executed by the master controller 73, font data, graphic functions, and various procedures.

The master controller 73 reads print data from the receive buffer in the interface (I/F) 72, converts the print data into intermediate codes, and loads the intermediate code data in the intermediate buffer defined in a prescribed area in the RAM 74. Then, the master controller 73 reads the intermediate code data and converts the intermediate code data into dot pattern data using font data stored in the ROM 75. The dot pattern data are loaded in another area in the RAM 74. If the inkjet printer receives bitmap data from the host that has converted the print data into the bitmap data, the printer controller 70 simply loads the received bitmap data in the RAM 74.

When a line of dot pattern data for the inkjet head 14 is acquired, the master controller 73 outputs the dot pattern data as serial data SD to the head driver 82 via the I/F 78, synchronized with the clock signal (CLK) supplied from the oscillating circuit 76, as illustrated in FIG. 5 and FIG. 6. In addition, the master controller 73 outputs a latch signal (LAT) to the head driver 82 at prescribed timing.

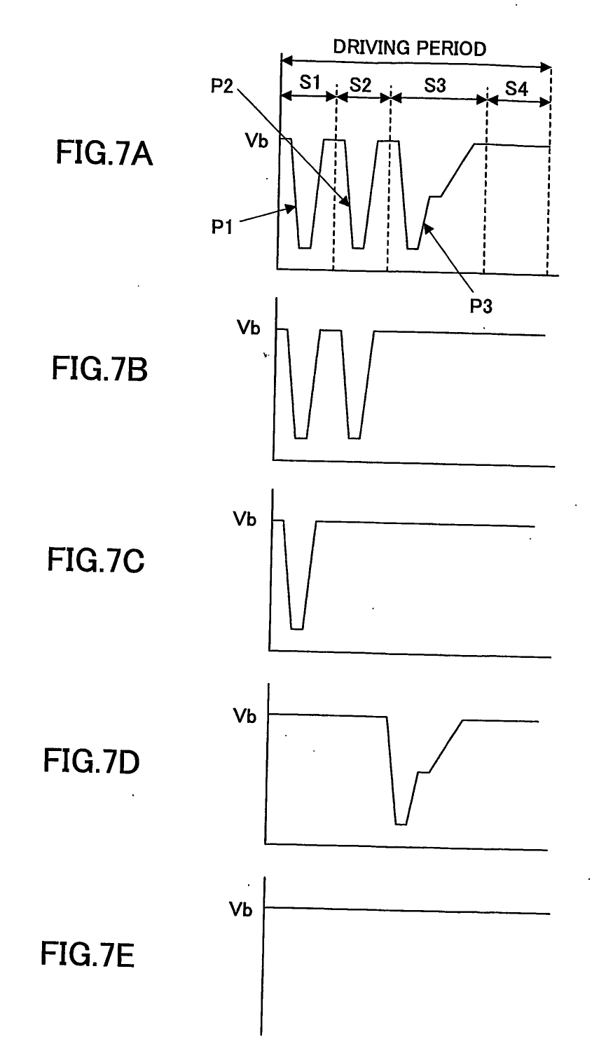

The driving signal generating circuit 77 includes a ROM (which may be constructed by the ROM 75) that stores the pulse pattern data of the driving signal Pv shown in FIG. 7. The driving signal generating circuit 77 also includes a waveform generator 91 having a D/A converter for digital-to-analog converting the driving waveform data read from the ROM, and an amplifier 92, as illustrated in FIG. 6.

The head driver 82 includes a shift register 95, a latch circuit 96, a level shifter 97, and an analog switch array 98. The shift register 95 receives the clock signal (CLK) and the serial data SD (converted from the print data) from the master controller 73. The latch circuit 96 latches the register values of the shift register 95 at a latch signal (LAT) supplied from the master controller 73. The level shifter 97 level-shifts the output value of the latch circuit 96. The analog switch array 98 is ON/OFF controlled by the level shifter 97.

The switch array 98 includes an array of switches AS1 through ASn, to which the driving signal Pv is input from the driving signal generating circuit 77. Each of the switches AS1-ASn is connected to one of the piezoelectric elements 52 corresponding to each of the nozzles of the inkjet head 14.

The dot pattern print data SD, which have been serially transmitted to the shift register 95, are latched by the latch circuit 96. The voltage of the latched print data is boosted by the level shifter 97 to a prescribed level (e.g., several tens volts) sufficient to drive the switches of the switch array 98. The level-shifted print data are input to the switch array 98.

A driving signal Pv is applied from the driving signal generating circuit 77 to the input stage of the switch array 98. The output stage of the switch array 98 is coupled to the piezoelectric elements 52, which function as the actuators or the pressure generating means. If the print data input to the switch array 98 is “1”, then the driving signal Pv with a prescribed waveform is applied to the corresponding piezoelectric element 52 to deform this piezoelectric element 52. When the print data input to the switch array 98 is “0”, no driving pulses are supplied to the piezoelectric element 52.

The shift register 95 and the latch circuit 96 are digital logic circuits, while the level shifter 97 and the switch array 98 are analog circuits.

FIG. 7A through FIG. 7E show general waveforms of driving pulses generated by a conventional inkjet printer in order to eject large, medium and small ink droplets.

When printing the image, a switching operation is carried out based on the control table shown in Table 1 to select a desired pulse among those shown in FIG. 7B through FIG. 7E with respect to the input pixel data. To eject a large ink droplet, the level of the print data (dot pattern data) applied to the switch array 98 is set to “1” in sections S1 and S2, and set to “0” in sections S3 and S4, based on Table 1. In this case, the first pulse P1 and the second pulse P2 are applied to the piezoelectric element 52, as illustrated in FIG. 7B. To eject a medium ink droplet, a switching operation is carried out based on Table 1 to apply only the first pulse P1 to the piezoelectric element 52. To eject a small ink droplet, only the third pulse P3 is applied to the piezoelectric element 52 based on Table 1.

TABLE 1

| | S1 | S2 | S3 | S4 |
|---|---|---|---|---|
| Large droplet | 1 | 1 | 0 | 0 |
| Medium droplet | 1 | 0 | 0 | 0 |
| Small droplet | 0 | 0 | 1 | 0 |
| Non-ejection | 0 | 0 | 0 | 1 |

Under the above-described switch control, an appropriate pulse is selected among those shown in FIG. 7B through FIG. 7E for each nozzle based on the print data, and is output to the corresponding piezoelectric element 52 every driving period to eject an ink droplet to print the image.

With an inkjet head capable of high-speed printing operation using a number of nozzles, ink droplets are ejected simultaneously from multiple channels, and the head itself shakes due to the reaction force opposite to the ink ejection force, especially when a solid color image is printed. If the frequency of the vibration agrees with the natural frequency of the inkjet head, ink droplets are not correctly ejected from the nozzles, and a defective image is reproduced.

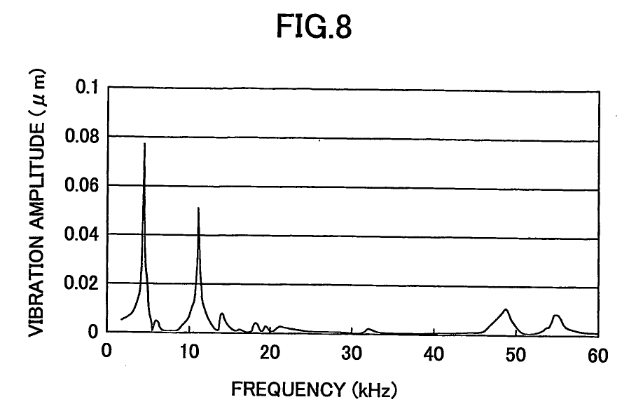

FIG. 8 is a graph showing the frequency characteristic of an inkjet head obtained when the actuators (piezoelectric elements 52) of all the channels are driven. The first-order resonance occurs at 4.5 kHz, and the second-order resonance occurs at 11.2 kHz.

In FIG. 7A, with the driving period of 125 μs, the printing operation is carried out at a frequency of 8 kHz or less. To print a dense image, ink droplets are ejected from multiple channels every driving period, and the head itself shakes at 8 kHz. Depending on the printed image or the printing method, ink droplets may be ejected from multiple channels every 250 μs (double driving period). In this case, the head shakes at 4 kHz because the actuators are driven at this frequency.

Actually, when the head having the frequency characteristic shown in FIG. 8 is driven at or near 4 kHz to print an image, the head resonates because the driving frequency is close to the natural frequency (4.5 kHz) of the head, and the printed image degrades.

To eliminate such a problem, a head driving signal is produced so as to drive the head at a frequency different from the resonant frequency of the head.

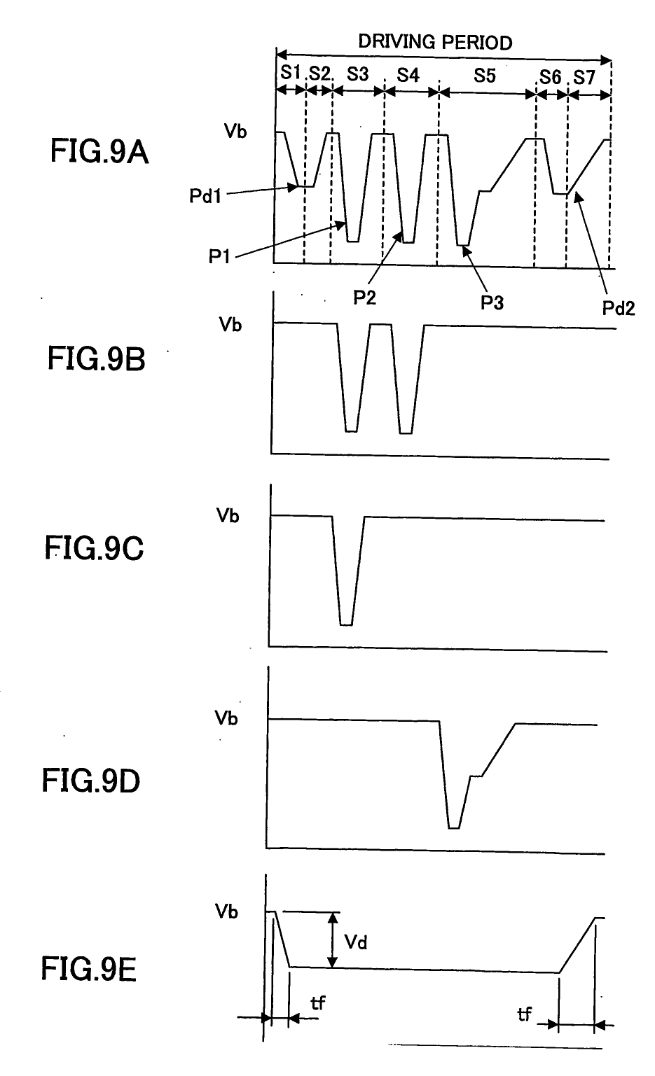

FIG. 9 is the first example of the waveforms of the head driving signal produced according to the preferred embodiment of the invention. The driving waveform includes dummy pulses Pd1 and Pd2 at the beginning and the end, respectively, which are non-ejecting pulses not to eject ink droplets. In the driving period, S1 is a section for producing the dummy pulse Pd1, S2 is a transition period from the dummy pulse Pd1 to generation of the first pulse P1, S3 is a section for producing the first pulse P1, S4 is a section for producing the second pulse P2, S5 is a section for producing the third pulse P3, S6 is a transition period from the third pulse P3 to the dummy pulse Pd2, and S7 is a section for the dummy pulse Pd2. The output waveform is selected based on the control table of Table 2.

TABLE 2

| | S1 | S2 | S3 | S4 | S5 | S6 | S7 |
|---|---|---|---|---|---|---|---|
| Large droplet | 0 | 0 | 1 | 1 | 0 | 0 | 0 |
| Medium droplet | 0 | 0 | 1 | 0 | 0 | 0 | 0 |
| Small droplet | 0 | 0 | 0 | 0 | 1 | 0 | 0 |
| Non-ejection | 1 | 0 | 0 | 0 | 0 | 0 | 1 |

With this driving signal, the pulses for large, medium and small ink droplets illustrated in FIG. 9B through FIG. 9D are the same as those shown in FIG. 7. However, when there are no print data, a driving signal that rises at dummy pulse Pd1, maintains the rising voltage (a potential difference Vd compared to Vb) and falls at dummy pulse Pd2, is output.

Using the driving signal with the waveform illustrated in FIG. 9, a satisfactory printed image can be obtained even if the inkjet head 14 with the frequency characteristic shown in FIG. 8 is driven at 4 kHz, because either the ink ejecting pulses shown in FIG. 9B through FIG. 9D or the non-ejecting (dummy) pulse shown in FIG. 9E are applied to the inkjet head 14. This means that the inkjet head 14 is driven at substantially 8 kHz, and the print data are reproduced as a printed image of a satisfactory print quality, without influence of resonance at 4 kHz.

When the non-ejecting pulse shown in FIG. 9E is applied, it is required not to eject an ink droplet. Accordingly, the flat voltage Vd after the voltage drop from Vb is set to a level not causing an ink droplet to be ejected, or alternatively, the slopes of the falling edge or the rising edge of the pulse are set gentle by appropriately selecting the time constant of fall and the time constant of rise. In view of the purpose of driving the inkjet head at a frequency other than the natural frequency, it is effective to set the non-ejecting voltage Vd large and to set the slopes of the falling edge and the rising edge gentle. However, if the slope is set gentle, the pulse width of the dummy signal becomes large, and the driving period becomes long. This results in a decreased printing rate, and therefore, it is not desired to set the pulse slope gentle more than is needed.

With a steep slope of the rising edge, the residual vibration occurs even if ink is not ejected. Such residual vibration makes the ink ejecting condition unstable. Accordingly, it is desired to set the rising slope gentler than the falling slope. If the non-ejecting pulse is a pulse drawing in the meniscus (a falling pulse), then the rate of voltage change in the meniscus drawing portion is set greater than the rate of voltage change in the meniscus restoring portion. This arrangement can produce a great effect of excitation with an improved swing of the non-ejecting pulse, and adverse effect of resonance can be avoided efficiently.

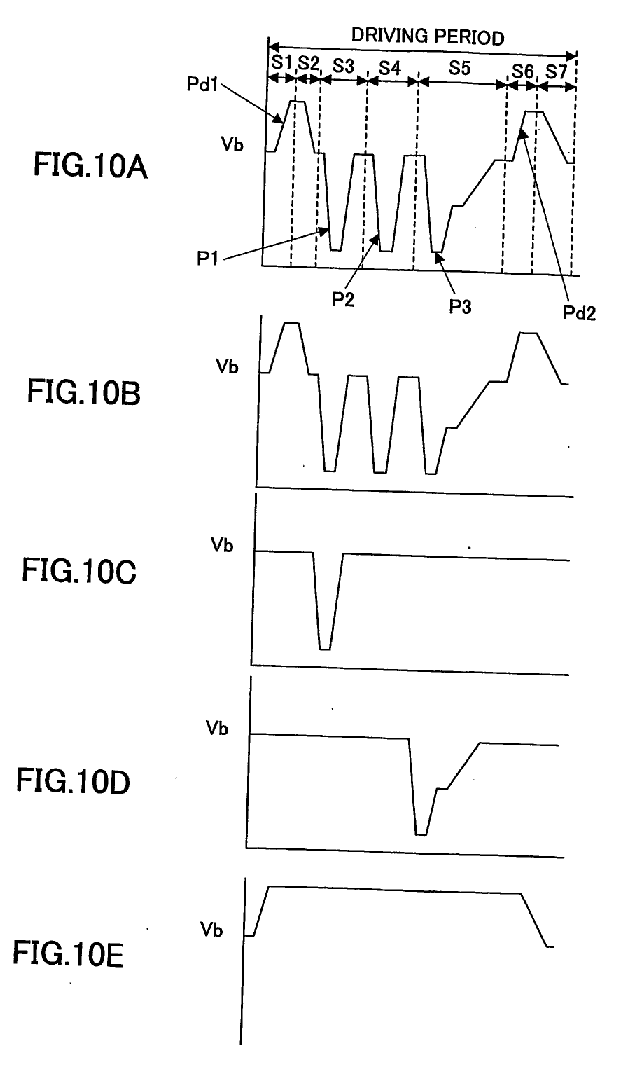

FIG. 10 is the second example of the waveforms of the head driving signal produced according to the preferred embodiment of the invention. This driving signal is a modification of the first example shown in FIG. 9. The polarities of the dummy pulses Pd1 and Pd2 with respect to the base voltage Vb are inverted, compared with the example shown in FIG. 9. By appropriately selecting a period from the driving waveform shown in FIG. 10A based on Table 2, each of the driving pulses shown in FIG. 10B through FIG. 10E is output.

Using this driving waveform, the inkjet head 14 is driven at a nonresonant frequency by applying the non-ejecting (dummy) pulse shown in FIG. 10E, and satisfactory print quality is obtained without the adverse affect of resonance.

It should be noted that the non-ejecting pulse shown in FIG. 10E has a profile that reduces the volume of the pressure chamber 46 (see FIG. 3). This non-ejecting pulse causes the meniscus in the nozzle opening 45 to rise up. If the area around the nozzle opening 45 is stained with ink mist, the gap between the meniscus and the ink stain may be bridged, which further promotes smirch on the nozzle surface.

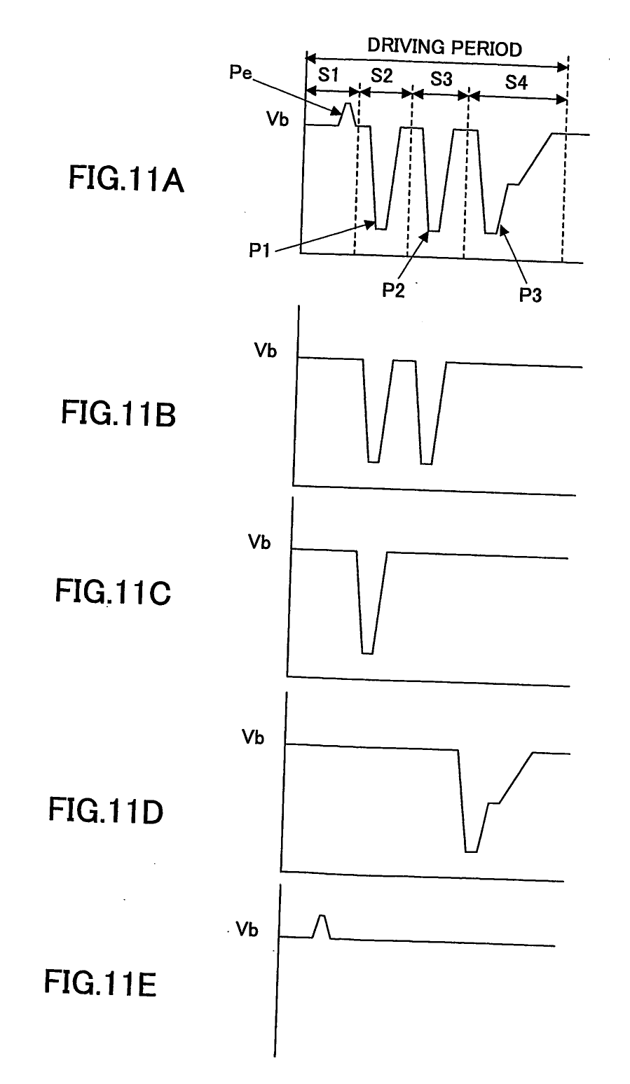

To avoid the undesirable smirch, the head driving signal with a profile shown in FIG. 11 is employed. With this driving signal, the non-ejecting pulse is produced so as not to maintain the meniscus at the swelled up position.

FIG. 11 is the third example of the waveforms of the head driving signal produced according to the preferred embodiment of the invention. A non-ejecting pulse Pe is inserted before the first pulse P1. By selecting an output waveform based on Table 3, each of the driving pulses shown in FIG. 11B through FIG. 11E is output.

TABLE 3

| | S1 | S2 | S3 | S4 |
|---|---|---|---|---|
| Large droplet | 0 | 1 | 1 | 0 |
| Medium droplet | 0 | 1 | 0 | 0 |
| Small droplet | 0 | 0 | 0 | 1 |
| Non-ejection | 1 | 0 | 0 | 0 |

It is preferable that the pulse width of the non-ejecting pulse Pe shown in FIG. 11E be shorter than the period of the pressure-induced resonance in the pressure chamber 46. The period of pressure-induced resonance is a wave period of the pressure wave produced in the pressure chamber 46 when a stepwise voltage signal is applied to the piezoelectric element 52.

By setting the pulse width of the non-ejecting pulse Pe shorter than the period of the pressure-induced resonance, the meniscus swells once and then is restored under the application of the non-ejecting pulse Pe, as illustrated in FIG. 11E. Consequently, undesirable stain or smirch which may be caused by the driving waveform shown in FIG. 10 can be avoided. In addition, the non-ejecting pulse Pe shown in FIG. 11E has an advantage in that the swelled meniscus takes in and cleans up the fine ink mist adhering in the vicinity of the nozzle opening 45. This arrangement can achieve stable ink ejection.

It should be noted that, with the head driving signal with the profile shown in FIG. 11, the effect of avoiding resonance of the inkjet head may be reduced because of the reduced width of the non-ejecting pulse.

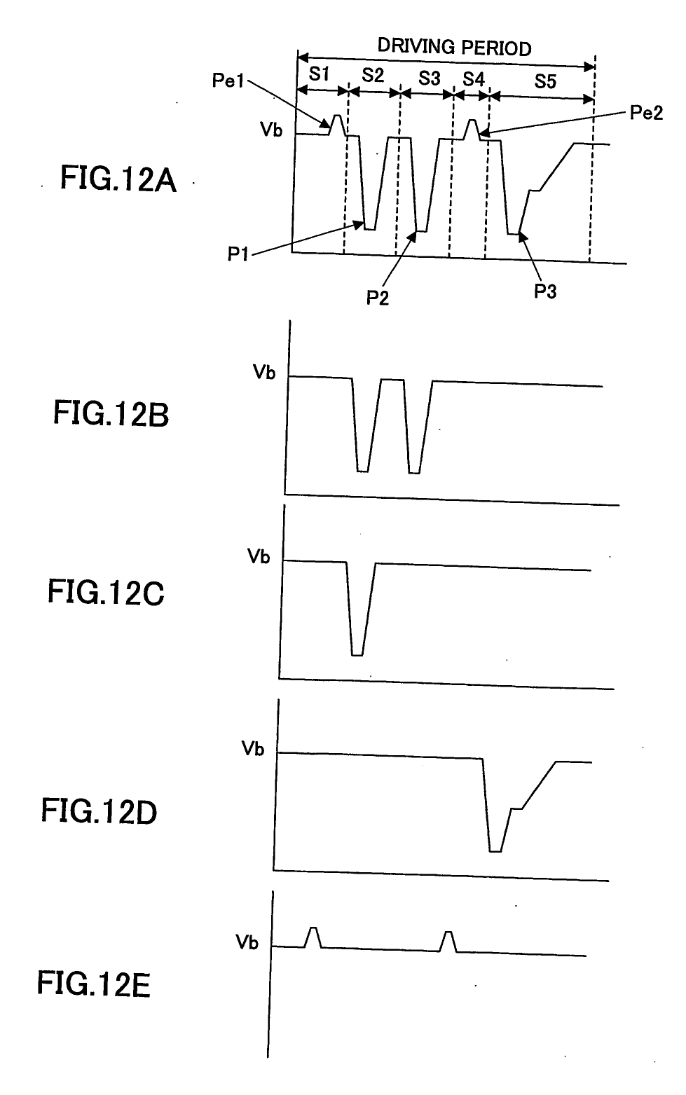

To further improve the head driving operation overcoming this point, the head driving signal with a profile shown in FIG. 12 is employed.

FIG. 12 is the fourth example of the waveforms of the head driving signal, in which non-ejecting pulses Pe1 and Pe2 are inserted in sections S1 and S4, respectively. By appropriately selecting an output waveform based on Table 4, each of the driving pulses shown in FIG. 12B through FIG. 12E can be output.

TABLE 4

| | S1 | S2 | S3 | S4 | S5 |
|---|---|---|---|---|---|
| Large droplet | 0 | 1 | 1 | 0 | 0 |
| Medium droplet | 0 | 1 | 0 | 0 | 0 |
| Small droplet | 0 | 0 | 0 | 0 | 1 |
| Non-ejection | 1 | 0 | 0 | 1 | 0 |

With this driving signal, the non-ejecting pulse is applied more frequently, as compared with the driving signal shown in FIG. 11. Consequently, the inkjet head is driven at a substantially higher frequency, and the excitation effect is increased. Although, in the example shown in FIG. 12, non-ejecting pulses are inserted at two positions, the number of non-ejecting pulses inserted in a driving period may be increased depending on the waveform. The positions at which the non-ejecting pulses are inserted can be determined appropriately based on the oscillating characteristic of the inkjet head.

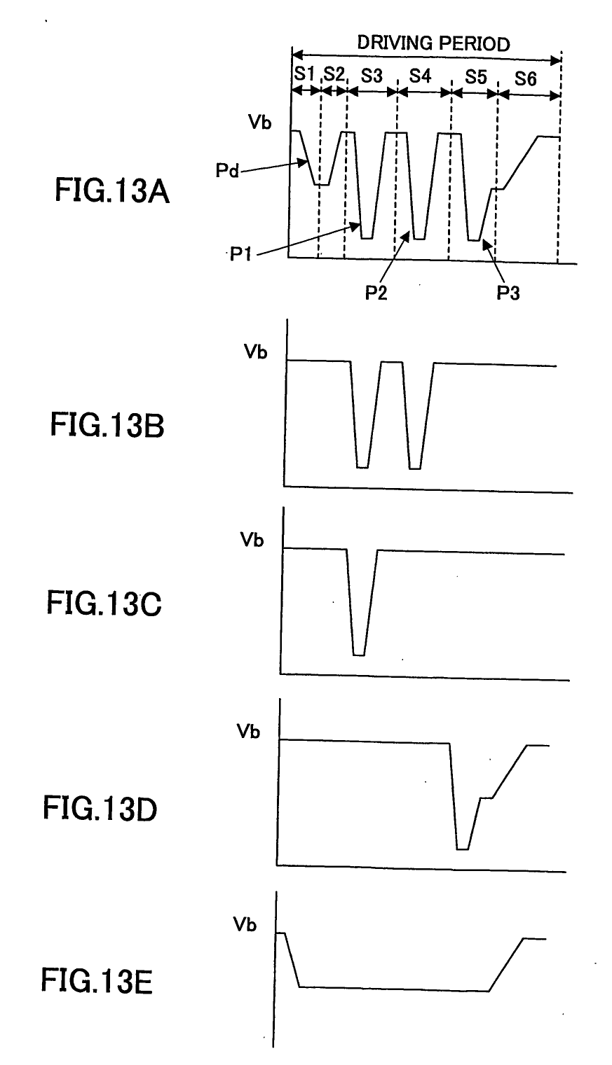

FIG. 13 is the fifth example of the waveforms of the head driving signal. The waveform shown in FIG. 13 is a modification of the first example shown in FIG. 9, and the second dummy pulse Pd2 is omitted. By appropriately selecting an output waveform from the driving signal shown in FIG. 13A based on Table 5, each of the driving pulses shown in FIG. 13B through FIG. 13E can be output.

TABLE 5

| | S1 | S2 | S3 | S4 | S5 | S6 |
|---|---|---|---|---|---|---|
| Large droplet | 0 | 0 | 1 | 1 | 0 | 0 |
| Medium droplet | 0 | 0 | 1 | 0 | 0 | 0 |
| Small droplet | 0 | 0 | 0 | 0 | 1 | 1 |
| Non-ejection | 1 | 0 | 0 | 0 | 0 | 1 |

In this example, the non-ejecting pulse is created making use of a portion of the third ejecting pulse P3, as illustrated in FIG. 13E. By making use of a portion of the waveform of the ejecting pulse, the total length of the driving signal can be shortened, and the printing speed can be increased.

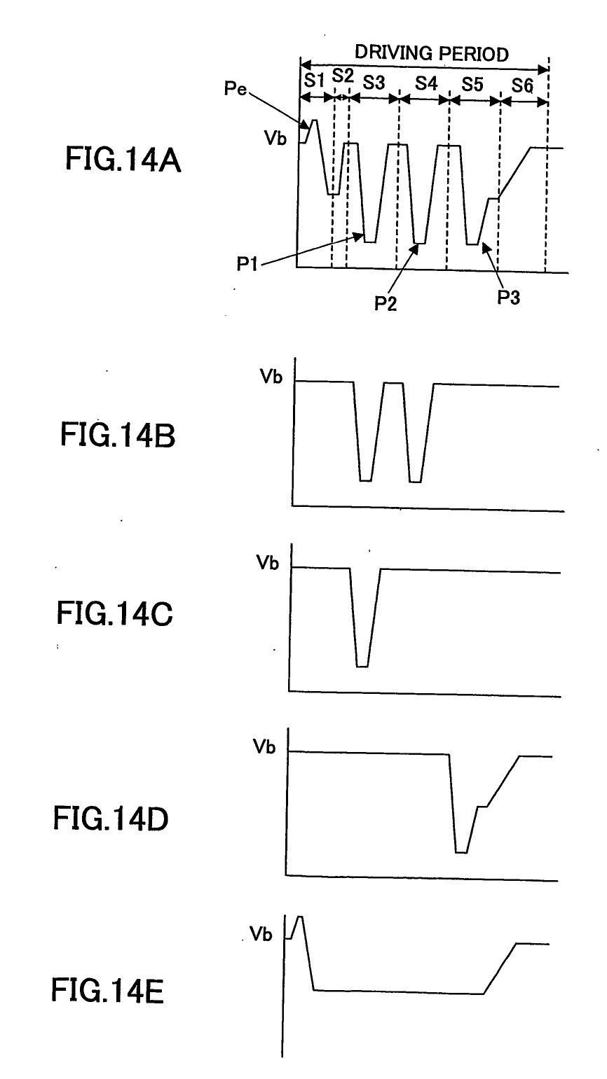

FIG. 14 is the sixth example of the waveforms of the head driving signal. This waveform is a modification of the fifth example shown in FIG. 13, and a non-ejecting pulse that rises and then falls in section S1 is employed. By appropriately selecting an output waveform from the driving signal shown in FIG. 14A based on Table 5, each of the driving pulses shown in FIG. 14B through FIG. 14E can be output.

The non-ejecting pulse shown in FIG. 14E is a composite pulse of a projecting short pulse shown in FIG. 11E and an indented long pulse shown in FIG. 13E.

The former projecting short pulse causes the meniscus to swell up quickly, which takes in and cleans up the adhesion of ink mist around nozzle openings. The consecutive indented pulse causes an improved excitation effect.

In other words, the non-ejecting pulse Pe includes the first pulse that pushes out the ink meniscus on the nozzle surface and the second pulse that follows the first pulse to pull in the meniscus. The pulse width of the first pulse is shorter than the period of the pressure-induced resonance in the pressure chamber, as has been explained above. In short, the non-ejecting pulse shown in FIG. 14E achieves an excitation effect with an improved pulse swing, while removing the adverse effect of resonance on the printed image quality efficiently. At the same time, the influence of undesirable ink mist that adheres to the nozzle surface during the continued printing operation can be removed. As a result, ejection of ink droplets can be performed in a stable manner.

By creating the non-ejecting pulse making use of a portion of the dummy pulse or the driving waveform, depending on the characteristics of the inkjet head, the adverse influence of the resonance of the head is cancelled, and high printing quality can be achieved.

Although the present invention has been described exemplifying the piezo-type inkjet head with the vibrating characteristic shown in FIG. 8, the printing method or the vibrating characteristic are not limited to these examples. The present invention is applicable to any type of image reproducing apparatus using inkjet printing equipment, as well as to any type of printing apparatus using an ejection head.

An actual example is now explained.

### EXAMPLE 1

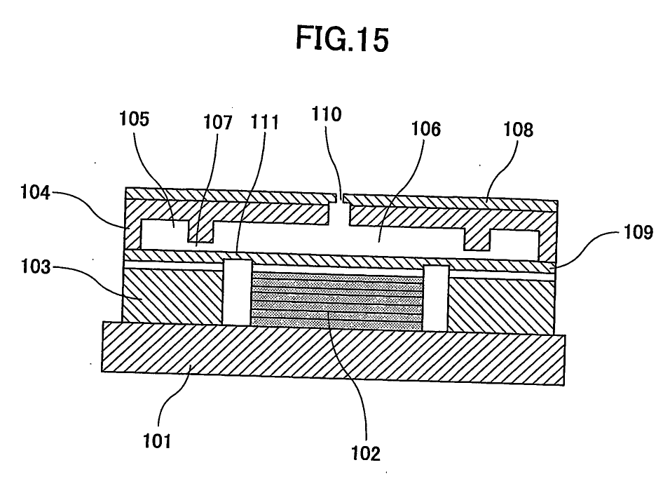

An inkjet head with a structure shown in FIG. 15 is prepared. A ceramic substrate 101 with a thickness of 2 mm and having an electrode pattern on it is prepared. A laminated piezoelectric device 102 is fixed to the top face of the substrate 101 using anaerobic adhesive.

Internal electrodes on the grounded (GND) side and internal electrodes on the high-voltage terminal (Hot) side are interlaced with each other, and the two groups of internal electrodes are connected to the external electrodes formed on two different electrically-insulated planes, respectively. In actual use, a voltage is to be applied across the external electrodes to cause each element of the piezoelectric device 102 to deform so as to induce ink ejecting pressure making use of the deformation in the laminated direction (or the thickness direction). A conductive paste is applied to the border between the Hot side external electrode and the substrate 101, which is then hardened to electrically connect the external electrode of the piezoelectric element 102 and the electrode pattern on the substrate 101.

The piezoelectric device 102 and the electrode pattern on the substrate 101 are divided into a plurality of sections by groove machining using a dicing saw at a pitch of about 85 μm. The GND side electrode on the substrate 101 is short-circuited by conductive paste. Then, a frame 103 made of an glass-reinforced epoxy resin is bonded onto the substrate 101 by epoxy resin. Finally, the top faces of the piezoelectric device 102 and the frame 103 are aligned with each other by surface grinding, and epoxy adhesive is applied onto the top surfaces of the piezoelectric device 102 and the frame 103 by silk screen. The liquid chamber unit is highly precisely positioned and bonded onto the frame 103 and the piezoelectric device 102.

The liquid chamber unit includes a channel plate 104, in which a common liquid flow channel 105, a pressure chamber 106, and a fluid resistor 107 are formed by etching a silicon substrate. The channel plate 104 is sandwiched between a nozzle plate 108 and a vibrating plate 109 fabricated by electroforming by applying epoxy adhesive to the interface between them. A nozzle opening 110 is formed in the nozzle plate 108 so as to communicate with the pressure chamber 106. Deformable diaphragms 111 are formed in the vibrating plate 109.

The fabricated inkjet head is filled with ink, a stepwise voltage is input to the head, and the response of the meniscus on the nozzle surface is measured by a laser Doppler vibrometer. The natural period Tc of vibration was about 12 μ sec. The vibration of the nozzle surface is measured, while sweeping the frequency, to evaluate the characteristic of the head. The resonant characteristic with the first peak at 4.5 kHz and the second peak at 11.2 kHz was confirmed.

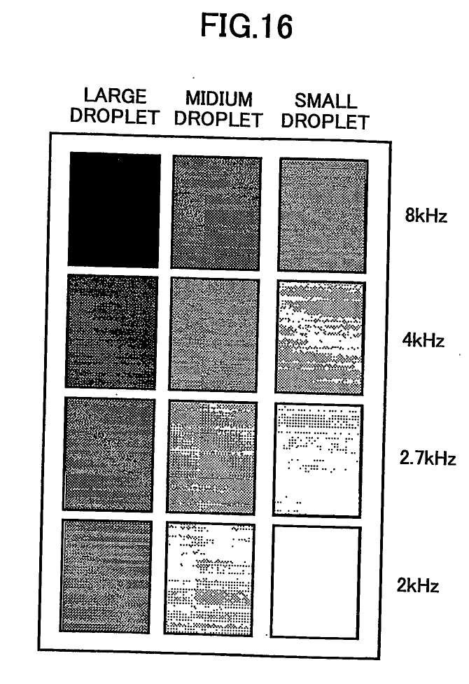

This inkjet head is mounted in a printer to evaluate the printed image by applying a conventional driving waveform shown in FIG. 7, which is capable of spraying large, medium, and small droplets at a 125 microsecond (μ sec) driving period. For the evaluation, a test pattern of solid color images of large, medium, and small droplets shown in FIG. 16 is used. Ink droplets are ejected from all the channels (nozzles) of the inkjet head at four different driving frequencies (8 kHz, 4 kHz, 2.7 kHz, and 2 kHz) to print the solid color images.

In the test result, satisfactory solid color images were obtained at 8 kHz, 2.7 kHz, and 2 kHz. However, horizontal streaks appeared in the medium droplet and small droplet solid color images at 4 kHz.

Next, a driving waveform shown in FIG. 9 making use of a dummy pulse according to an embodiment of the present invention is used, and the same evaluation was performed. With this driving signal, a non-ejecting (dummy) pulse shown in FIG. 9E that does not cause an ink droplet to be ejected from the nozzle is applied to the inkjet head in the non-printing range. A satisfactory printed image without horizontal streaks was obtained even at a driving frequency of 4 kHz.

Next, evaluation was made using the non-ejecting dummy pulse Vd shown in FIG. 9E as a parameter in order to examine the preferable voltage range of the non-ejecting pulse. The pulse falling time tf and the pulse rising time tr were set to 3 μ sec. The evaluation result is shown in Table 6.

In Table 6, the negative value of the non-ejecting voltage Vd represents that the applied pulse has an opposite polarity (as shown in FIG. 10E), as compared with the non-ejecting pulse shown in FIG. 9E. The “print quality” is the initial image quality observed from the printed test pattern at the beginning. The “endurance” is evaluated by observing degradation of the print quality after the test patterns are printed consecutively a number of times. The circle in Table 6 indicated a satisfactory result, and the cross mark indicates a poor result.

TABLE 6

| EVALUATION | Vd [V] | | | | | | | | | | |
|---|---|---|---|---|---|---|---|---|---|---|---|
| ITEM | −10 | −8 | −6 | −4 | −2 | 0 | 2 | 4 | 6 | 8 | 10 |
| PRINT | X | X | ◯ | ◯ | X | X | X | ◯ | ◯ | X | X |
| QUALITY | | | | | | | | | | | |
| ENDURANCE | — | — | X | X | — | — | — | ◯ | ◯ | — | — |

In Table 6, at voltages of −10 V, −8 V, 8V, and 10 V, ink adhesion was observed in the margins or the background in the evaluation of the initial print quality. This means that some ink droplets were ejected from the nozzle under the application of the non-ejecting dummy pulse during the non-printing period. In the range from −2 V to 2V, image degradation occurred in the test pattern image at a driving frequency of 4 kHz.

Then, an endurance test was conducted by consecutively printing 500 sheets of test pattern image only under the satisfactory conditions of the initial print quality test. When the non-ejecting voltage is −6 V and −4 V, the printed image is deteriorated, and in the worst case, the nozzle comes off. In contrast, at a voltage of 4 V and 6 V, a satisfactory printed image was obtained even after the consecutive printing operation of 500 sheets of test pattern.

Next, a comparative evaluation was performed using the driving waveform shown in FIG. 10 or FIG. 11. Voltage Vd is set to 5 V, and pulse width is varied among 3, 8, 12, 16, 20, 30, and 100 μ sec. The evaluation result is shown in Table 7. As to the symbols, a circle represents a satisfactory result, a triangle represents a fair result, and a cross represents a poor result.

TABLE 7

| EVALUATION | PULSE WIDTH [μs] | | | | | | |
|---|---|---|---|---|---|---|---|
| ITEM | 3 | 8 | 12 | 16 | 20 | 30 | 100 |
| PRINT | Δ | Δ | Δ | Δ | Δ | ◯ | ◯ |
| QUALITY | | | | | | | |
| ENDURANCE | ◯ | ◯ | ◯ | Δ | Δ | X | X |

Concerning the initial print quality, satisfactory print image quality is obtained with a long pulse width. With a shorter pulse width, slight streaks were observed in the small-droplet image at 4 kHz. Then, in the endurance test after the consecutive printing operation of 500 sheets of test pattern, a satisfactory result is obtained with a pulse width less than or equal to 12 μ sec, which is the natural period Tc of meniscus vibration of the inkjet head. With the pulse width of 16 μ sec and 20 μ sec, unevenness of print density was observed in the small-droplet image, which may be due to the curved ejection path. With the pulse width of 30 μ sec and 100 μ sec, streaks are observed in the printed image.

Next, the driving waveform shown in FIG. 12 with two dummy pulses (Pe1 and Pe2) is applied to the inkjet head, while setting the pulse width to 8 μm. 500 sheets of test pattern were printed consecutively. Satisfactory result was obtained in both the initial print quality and endurance.

Next, a comparative evaluation was made using the driving waveform illustrated in FIG. 14, in which the first non-ejecting pulse is produced in S1 and the second non-ejecting pulse is generated as a portion of the small-droplet ejecting pulse P3 in S6. The time period from the start of pulse rising to the fall of the pulse in S1 is 5 μ sec, and the pulse rising time in S6 is 10 μ sec. The peak voltage of the first non-ejecting pulse in S1 is 5 volts higher than the base voltage Vb, and the bottom voltage is 10 volts lower than the base voltage Vb so as to agree with the voltage level of the third ejecting pulse P3.

With this driving waveform, satisfactory results were obtained in both the initial print quality and endurance after the consecutive printing operation. Since in the driving waveform shown in FIG. 14 the slope of the rising edge of the non-ejecting pulse in S6 is set gentle, significant excitation effect is achieved, without causing damage to occur as indicated in Table 6 when the non-ejecting voltage is set large.

As has been described above, the ejection head is driven at a driving frequency other than the resonant frequency of the ejection head, and consequently, adverse effect of resonance can be reduced with a simple structure. Consequently, print quality can be improved under stable operations.

Although in the above-described examples, the thickness mode (d33 effect) PZT is used as the piezoelectric device, an elastic vibration type PZT may also be used. The higher reliability of the device is obtained when using the thickness mode (d33) PZT. The present invention is applicable not only to a piezoelectric type inkjet head, but also to driving a thermal type or a electrostatic type inkjet head.

Although the image reproducing apparatus descried in the embodiment employs an inkjet head to produce a printed image, the present invention is applicable to any type of liquid droplet ejection head used in an image reproducing and forming apparatus. For example, the invention can be applied to a resist pattern forming apparatus with an ejection head for ejecting a liquid resist, or a sample pattern producing apparatus with an ejection head for ejecting gene analysis liquid samples.

1. An image reproducing and forming apparatus comprising:
an ejection head configured to eject a liquid droplet from a nozzle to form an image on a medium;
a driving signal generating unit configured to generate a driving signal having a waveform that causes the ejection head to operate at a driving frequency other than the natural frequency of the ejection head; and
a driving unit configured to drive the ejection head based on the driving signal supplied from the driving signal generating unit.

2. The image reproducing and forming apparatus of claim 1, wherein the driving signal generating unit produces the driving signal including a non-ejecting pulse that produces energy for not ejecting the droplet, and the driving unit applies the non-ejecting pulse to the ejection head in a non-printing range in order to drive the ejection head at the driving frequency other than the natural frequency of the ejection head.

3. The image reproducing and forming apparatus of claim 2, wherein the driving signal generating unit produces the non-ejecting pulse, making use of a portion of an ejecting pulse of the driving signal.

4. The image reproducing and forming apparatus of claim 2, wherein the driving signal generating unit produces the non-ejecting pulse that draws in a meniscus of the nozzle.

5. The image reproducing and forming apparatus of claim 2, wherein the driving signal generating unit produces the non-ejecting pulse that pushes out a meniscus of the nozzle and has a pulse width smaller than a period of pressure-induced resonance in a liquid chamber of the ejection head.

6. The image reproducing and forming apparatus of claim 2, wherein the non-ejecting pulse has a falling edge with a first rate of voltage change and a rising edge with a second rate of voltage change that is smaller than the first rate of voltage change.

7. The image reproducing and forming apparatus of claim 2, wherein the non-ejecting pulse includes a first portion that draws in a meniscus of the nozzle with a first rate of voltage change and a second portion that restores the meniscus of the nozzle with a second rate of voltage change smaller than the first rate of voltage change.

8. The image reproducing and forming apparatus of claim 2, wherein the non-ejecting pulse includes a first waveform that pushes out a meniscus of the nozzle and a second waveform that follows the first waveform to draw in the meniscus of the nozzle, the first waveform having a pulse width smaller than a resonant frequency of a liquid chamber of the ejection head.

9. The image reproducing and forming apparatus of claim 2 , wherein the driving signal includes a first non-ejecting signal inserted at a beginning of the driving signal and a second non-ejecting signal inserted at an end of the driving signal.

10. The image reproducing and forming apparatus of claim 2, wherein the ejection head includes an actuator for producing a pressure to eject the droplet, and the driving signal including the non-ejecting pulse is applied to the actuator.
